(19) United States
(12) Patent Application Publication
(10) Pub. No.: US 2025/0334311 A1
(43) Pub. Date: Oct. 30, 2025

(54) REFRIGERATION CYCLE DEVICE AND CONTROL METHOD

(71) Applicant: Mitsubishi Electric Corporation, Tokyo (JP)

(72) Inventors: Hirokazu KONISHI, Tokyo (JP); Takahiro NAKAI, Tokyo (JP); Kazunori TSUCHINO, Tokyo (JP); Yuki MORI, Tokyo (JP)

(73) Assignee: Mitsubishi Electric Corporation, Tokyo (JP)

(21) Appl. No.: 18/855,361

(22) PCT Filed: Apr. 18, 2022
(86) PCT No.: PCT/JP2022/017990

§ 371 Date: Oct. 9, 2024

(51) Int. Cl. F25B 49/02

(52) U.S. Cl. CPC F25B 49/022

(57) ABSTRACT

A refrigeration cycle device includes a compressor, a condenser, an expansion valve, an evaporator, an indoor fan, a control device that controls a rotation speed of the indoor fan and a frequency of the compressor, a room temperature detector that detects a room temperature, and an evaporation temperature detector that detects an evaporation temperature of a refrigerant in the evaporator. The control device includes a room temperature control unit that calculates the rotation speed of the indoor fan at which the room temperature is caused to approach a predetermined room temperature, and an evaporation temperature control unit that calculates the frequency of the compressor at which the evaporation temperature is caused to approach a predetermined refrigerant temperature. The room temperature is individually controlled by the indoor fan, and the evaporation temperature is individually controlled by the compressor.

### TECHNICAL FIELD

The present disclosure relates to a refrigeration cycle device and a control method.

### BACKGROUND ART

A refrigeration cycle device constituting a refrigerant circuit in which a refrigerant circulates is generally known (see, for example, Patent Reference 1).

### PRIOR ART REFERENCE

### Patent Reference

Patent Reference 1: Japanese Patent Application Publication No. H09-14724

### SUMMARY OF THE INVENTION

### Problem to be Solved by the Invention

Conventionally, a technique of switching operation between cooling operation for keeping a comfortable room temperature and dehumidifying operation for keeping a comfortable room humidity has been employed. However, it is difficult for the conventional technique to keep the comfortable room temperature and the comfortable room humidity.

It is therefore an object of the present disclosure to control a room temperature and a room humidity individually to keep a comfortable room temperature and a comfortable room humidity.

### Means of Solving the Problem

A refrigeration cycle device according to the present disclosure includes:
a compressor that compresses a refrigerant;
a condenser;
an expansion valve;
an evaporator;
an indoor fan;
a control device that controls a rotation speed of the indoor fan and a frequency of the compressor;
a room temperature detector that detects a room temperature; and
an evaporation temperature detector that detects an evaporation temperature of a refrigerant in the evaporator, wherein
the control device includes
a room temperature control unit including a controller that calculates the rotation speed of the indoor fan at which the room temperature is caused to approach a predetermined room temperature, and
an evaporation temperature control unit including a controller that calculates the frequency of the compressor at which the evaporation temperature is caused to approach a predetermined refrigerant temperature, and
the room temperature is individually controlled by the indoor fan, and the evaporation temperature is individually controlled by the compressor.

A control method according to the present disclosure is a control method in a refrigeration cycle device including a compressor that compresses a refrigerant, a condenser, an expansion valve, an evaporator, an indoor fan, a control device that controls a rotation speed of the indoor fan and a frequency of the compressor, a room temperature detector that detects a room temperature, and an evaporation temperature detector that detects an evaporation temperature of a refrigerant in the evaporator, and the method includes:
calculating the rotation speed of the indoor fan at which the room temperature is caused to approach a predetermined room temperature; and
calculating the frequency of the compressor at which the evaporation temperature is caused to approach a predetermined refrigerant temperature, wherein
the room temperature is individually controlled by the indoor fan, and the evaporation temperature is individually controlled by the compressor.

### Effects of the Invention

According to the present disclosure, a room temperature and a room humidity are individually controlled so that a comfortable room temperature and a comfortable room humidity can be thereby kept.

### BRIEF DESCRIPTION OF THE DRAWINGS

FIG. 1 is a diagram schematically illustrating an example of a configuration of a refrigeration cycle device according to a first embodiment.

FIG. 2 is a block diagram schematically illustrating a configuration of a control device illustrated in FIG. 1.

FIG. 3 is a functional block diagram showing functions of the control device illustrated in FIG. 1.

FIG. 4 is a flowchart schematically showing an example of a control method for controlling a room temperature and an evaporation temperature in the refrigeration cycle device.

FIG. 5 is a functional block diagram showing another example of the control device.

FIG. 6 is a functional block diagram showing yet another example of the control device.

FIG. 7 is a functional block diagram showing still another example of the control device.

FIG. 8 is a graph showing a comparison between operation in a conventional refrigeration cycle device and operation in the refrigeration cycle device according to the first embodiment.

FIG. 9 is a graph showing an operation range of the refrigeration cycle device.

FIG. 10 is a functional block diagram showing still another example of the control device.

FIG. 11 is a flowchart showing an example of a method for controlling a compressor frequency so that an evaporation temperature approaches an evaporation temperature target value.

### MODE FOR CARRYING OUT THE INVENTION

A refrigeration cycle device 1 according to the present disclosure will be described with reference to the drawings. Note that components denoted by the same reference characters in the drawings correspond to the same or corresponding components, and this is common throughout the entire specification.

### First Embodiment

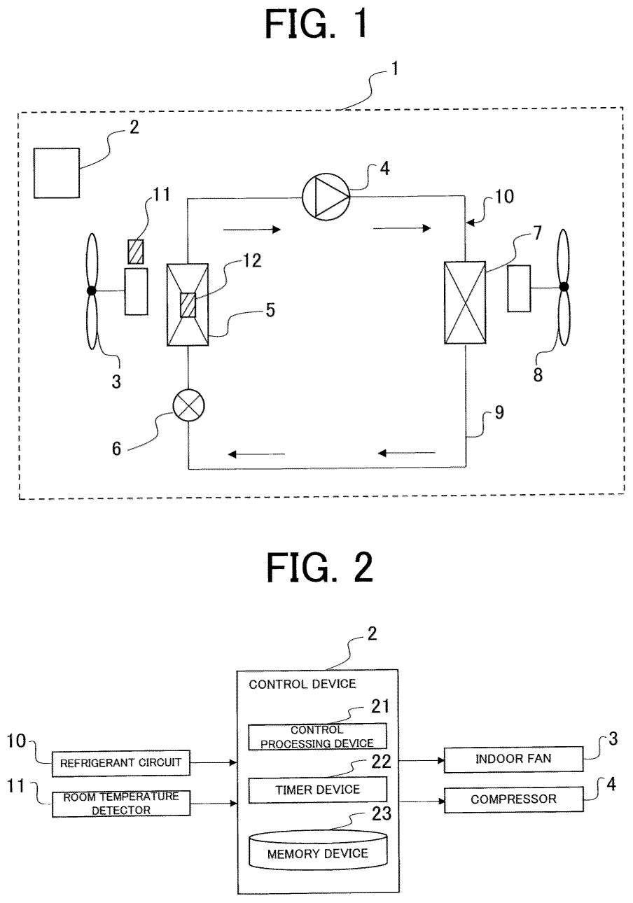

FIG. 1 is a diagram schematically illustrating an example of a configuration of a refrigeration cycle device 1 according to a first embodiment.

As illustrated in FIG. 1, the refrigeration cycle device 1 includes a control device 2, an indoor fan 3, a compressor 4 that compresses a refrigerant, an evaporator 5, an electronic expansion valve 6 serving as an expansion valve, a condenser 7, a room temperature detector 11, and an evaporation temperature detector 12. The compressor 4, the evaporator 5, the electronic expansion valve 6, and the condenser 7 are connected by a pipe 9 to form a refrigerant circuit 10. A refrigerant flows in the refrigerant circuit 10. In FIG. 1, solid arrows indicate a direction of the flow of the refrigerant.

The refrigeration cycle device 1 may further include a four-way valve, an accumulator (also called “liquid trap”), an injection circuit, a receiver circuit, or a power receiver circuit. The four-way valve is located at a pipe connected to each of an inlet and an outlet of the compressor 4, and switches a flow of a refrigerant gas. The accumulator is located between the compressor 4 and the evaporator 5, and prevents suction of a refrigerant not gasified by the evaporator into the compressor. The injection circuit suppresses an increase in a discharge temperature of the compressor 4. The receiver circuit or the power receiver circuit is located between the condenser 7 and the evaporator 5 and stores a redundant refrigerant. The following description refers to a case where the refrigeration cycle device 1 is an air conditioner, but the refrigeration cycle device 1 is not limited to the air conditioner.

The indoor fan 3 sucks indoor air into the refrigeration cycle device 1 (e.g., indoor unit of the air conditioner) and sends cool air or warm air subjected to heat exchange into the room. In the indoor fan 3, an indoor fan speed (i.e., driving rotation speed) is controlled by a control circuit such as an inverter circuit. In this case, the control circuit can change the indoor fan speed of the indoor fan 3. Consequently, the airflow rate of the indoor fan 3 changes. That is, the amount of air sent by the indoor fan 3 per a unit time changes. It is sufficient that a resolution of the indoor fan speed of the indoor fan 3 is 100 rpm or less.

The compressor 4 compresses a refrigerant and discharges the compressed refrigerant. A driving frequency of the compressor 4 may change by, for example, a control circuit such as an inverter circuit. In this case, the volume of the compressor 4 changes. That is, the amount of a refrigerant sent by the compressor 4 per a unit time changes.

The evaporator 5 performs heat exchange between a refrigerant and air, evaporates and vaporizes the refrigerant, and cools air.

The electronic expansion valve 6 is, for example, an expansion valve whose opening degree is changeable. The electronic expansion valve 6 controls the discharge temperature at an outlet of the compressor 4 and a suction superheat of the compressor 4, and does not control the evaporation temperature with a specific target value.

The condenser 7 performs heat exchange between a refrigerant and air, condenses the refrigerant to liquefy the refrigerant, and heats air.

As illustrated in FIG. 1, the refrigeration cycle device 1 includes, for example, the room temperature detector 11 and the evaporation temperature detector 12.

The room temperature detector 11 is located at, for example, an inlet of the indoor unit of the air conditioner. The room temperature detector 11 detects a temperature in a room. Specifically, the room temperature detector 11 detects a temperature of room air sucked into the indoor unit. The temperature of room air sucked into the indoor unit will be also referred to as a “room temperature.”

A temperature detected by the room temperature detector 11 may be, for example, an ambient temperature of a remote controller for operating the air conditioner. In this case, the temperature of air detected by the remote controller is sent to the room temperature detector 11, for example.

The temperature detected by the room temperature detector 11 may be, for example, a temperature of air detected by a temperature sensor provided in the room. In this case, the temperature of air detected by the temperature sensor is sent to the room temperature detector 11, for example.

The temperature detected by the room temperature detector 11 may be, for example, a temperature of air detected by an infrared sensor provided in the indoor unit of the air conditioner. In this case, thermal image information indicating the temperature of air obtained by the infrared sensor is sent to the room temperature detector 11, for example.

The evaporation temperature detector 12 is located in the pipe 9 on the outlet side of the evaporator 5, for example. The evaporation temperature detector 12 detects an evaporation temperature of the refrigerant in the evaporator 5. The evaporation temperature detector 12 is constituted by, for example, a thermocouple, a thermistor, a pressure sensor, or other devices. In the case of the thermocouple and the thermistor, the evaporation temperature detector 12 detects a temperature of a two-phase portion (i.e., portion where gas and liquid are mixed) in the heat exchanger of the indoor unit. In the case of the pressure sensor, the evaporation temperature detector 12 detects a pressure in the heat exchanger of the indoor unit, and converts the pressure to a saturation temperature to use the saturation temperature as an evaporation temperature. The evaporation temperature detector 12 may detect information corresponding to an evaporation temperature such as a low pressure, instead of the evaporation temperature.

FIG. 2 is a block diagram schematically illustrating a configuration of the control device 2 illustrated in FIG. 1.

As illustrated in FIG. 2, the sensors described above are connected to the control device 2, and data on temperatures from the sensors is input to the control device 2. An instruction or the like from a user of the refrigeration cycle device 1 is input to the control device 2 through operation unit (not shown). The control device 2 is included in at least one of an indoor unit or an outdoor unit of the air conditioner. That is, the control device 2 may be included in each of the indoor unit and the outdoor unit of the air conditioner or may be included in one of the indoor unit and the outdoor unit. For example, in a case where a component (e.g., first control unit) for controlling a rotation speed of the indoor fan 3 is included in the indoor unit of the air conditioner and a component (e.g., second control unit) for controlling a frequency of the compressor 4 is included in the outdoor unit of the air conditioner, these components (first control unit and second control unit) will be collectively referred to as a “control device 2.”

As illustrated in FIG. 2, the control device 2 includes a control processing device 21, a memory device 23, and a timer device 22. The control processing device 21 performs processing such as computation and determination and controls equipment of the refrigeration cycle device 1 such as the indoor fan 3 and the compressor 4, based on input temperature information. The memory device 23 includes a volatile memory device (not shown) such as a random access memory (RAM) capable of temporarily storing data, and a nonvolatile auxiliary memory device (not shown) such as a hard disk or a flash memory capable of storing data for a long term. The timer device 22 is constituted by, for example, a timer and counts time. The timer device 22 is used for determination or the like of the control processing device 21.

The control processing device 21 can be constituted by, for example, a microcomputer including a control arithmetic processing unit such as a central processing unit (CPU). The memory device 23 includes data in which a processing procedure to be performed by the control processing device 21 is programmed. The control arithmetic processing unit executes processing based on data of the program to perform control. Each device can be constituted by dedicated equipment (hardware).

The control device 2 controls a rotation speed of the indoor fan 3 and a frequency of the compressor 4. In calculating an indoor fan speed of the indoor fan 3, the control device 2 refers to a room temperature detected by the room temperature detector 11 and a room temperature set by a user of the refrigeration cycle device 1, and uses a predetermined control gain. In calculating the frequency of the compressor 4, the control device 2 refers to a temperature of the evaporator 5 and a target value previously stored in the memory device 23, and uses a predetermined control gain.

Operation of the refrigeration cycle device 1 will be described below with reference to FIG. 1.

A gas refrigerant turned to be in a high-temperature and high-pressure state by compression by the compressor 4 is discharged from the outlet of the compressor 4 and flows into the condenser 7. The gas refrigerant that has flowed into the condenser 7 releases heat and is liquefied under a high pressure in the condenser 7, and flows out from the condenser 7. The liquid refrigerant that has flowed out from the condenser 7 is decompressed by the electronic expansion valve 6 to be in a low-temperature two-phase state, and flows into the evaporator 5. The low-temperature two-phase refrigerant that has flowed into the evaporator 5 takes heat and is vaporized under a low pressure in the evaporator 5, and flows out from the evaporator 5. The refrigerant that has flowed out from the evaporator 5 is sucked in the compressor 4 and compressed again. Through repetition of such operation, a refrigeration cycle of the refrigeration cycle device 1 is achieved.

Next, dehumidifying operation will be described with reference to FIG. 1. The indoor fan 3 blows indoor air to a pipe through which the low-temperature two-phase refrigerant that has flowed into the evaporator 5 flows so that the inflow low-temperature two-phase refrigerant takes heat from the temperature of the indoor air to be gasified under a low pressure. At this time, in a case where the temperature of the pipe in which the low-temperature two-phase refrigerant that has flowed into the evaporator 5 flows is lower than a dew point of the indoor air, moisture included in the air blown by the indoor fan 3 condenses, and the condensed moisture is released to the outside of the room through a drain (not shown). In this manner, dehumidifying operation of the refrigeration cycle device 1 is performed.

The refrigerant circuit 10 illustrated in FIG. 1 has a minimum configuration for performing a refrigeration cycle in the refrigeration cycle device 1 according to the present disclosure, and the refrigeration cycle device 1 may include a four-way valve for switching a refrigerant channel, an accumulator for suppressing suction of a liquid refrigerant into the compressor 4, and/or other devices, as necessary. In the present disclosure, in the condenser 7 and the evaporator 5, heat exchange is performed between air and a refrigerant, but heat exchange is not necessarily performed between a refrigerant and air. For example, heat exchange may be performed between a refrigerant and water.

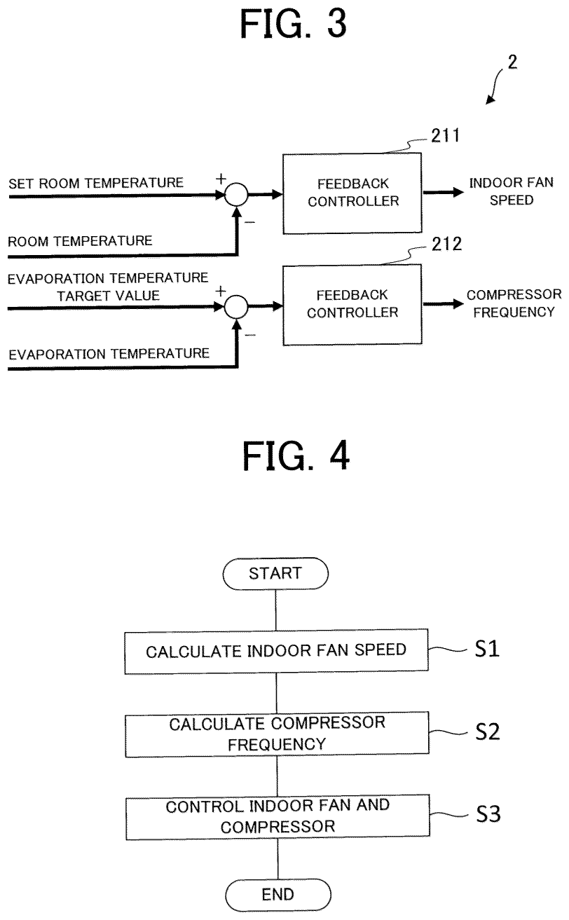

FIG. 3 is a functional block diagram showing functions of the control device 2 illustrated in FIG. 1.

As illustrated in FIG. 3, the control device 2 includes a room temperature control unit 211 and an evaporation temperature control unit 212.

The room temperature control unit 211 controls the room temperature so that the room temperature approaches a predetermined room temperature (also referred to as a “set room temperature”). For example, the room temperature control unit 211 includes a controller that calculates a rotation speed of the indoor fan 3 at which the room temperature is caused to approach the set room temperature. The rotation speed of the indoor fan 3 will be also referred to as an “indoor fan speed.” The controller of the room temperature control unit 211 includes at least an integrator. The “integrator” herein refers to an integrator that performs integral operation.

The controller of the room temperature control unit 211 is constituted by, for example, a feedback controller. In the example illustrated in FIG. 3, design response of the feedback controller of the room temperature control unit 211 is a first-order lag system. More specifically, in a case where a control target model for controller design is a first-order lag system or a dead time+first-order lag system, the room temperature control unit 211 is constituted by a PI controller. In this case, as shown in Equation (1), a deviation between a predetermined set room temperature Trₛₑₜ [deg C.] and a room temperature Tr [deg C.] acquired from the room temperature detector 11 (i.e., ΔTr=Trₛₑₜ−Tr) is input to the PI controller, and the PI controller calculates an indoor fan speed at which the room temperature is caused to follow the set room temperature, and controls the indoor fan speed to an arithmetic value U_{ifan} [rpm]. In this application, the “PI controller” refers to a controller constituted by a P controller and an I controller, the “P controller” refers to a proportioner, and the “I controller” refers to an integrator.

$${U}_{ifan} = {K}_{pr} Δ Tr + {K}_{Ir} \int Δ Trdt \qquad Equation ( 1 )$$

In Equation (1), Kₚᵣ is a proportional gain for PI control, and Kir is an integral gain for PI control. Control performed by the room temperature control unit 211 may be PID control depending on design response or a control target model for design. If there is no deviation from the set room temperature and only simple control is required, the control performed by the room temperature control unit 211 may be I control.

These control gains such as the proportional gain and the integral gain are designed by a method such as a pole assignment method, a CHR method, or a Ziegler-Nichols method (ZN method). The room temperature control unit 211 needs to be discretized using a microcomputer, a DSP, or the like during implementation, but the computation method thereof may be positional or speed-based.

The evaporation temperature control unit 212 controls the evaporation temperature so that the evaporation temperature approaches a predetermined refrigerant temperature (also referred to as an “evaporation temperature target value”). For example, the evaporation temperature control unit 212 includes a controller that calculates a frequency of the compressor 4 at which the evaporation temperature is caused to approach the evaporation temperature target value. The frequency of the compressor 4 will be also referred to as a “compressor frequency.” The controller of the evaporation temperature control unit 212 includes at least an integrator.

The controller of the evaporation temperature control unit 212 is constituted by, for example, a feedback controller. The feedback controller of the evaporation temperature control unit 212 makes the evaporation temperature approach the evaporation temperature target value. For example, design response of the feedback controller of the evaporation temperature control unit 212 illustrated in FIG. 3 is a first-order lag system. More specifically, in the case where the control target model for controller design is a first-order lag system or a dead time+first-order lag system, the evaporation temperature control unit 212 is constituted by a PI controller. In this case, as shown in Equation (2), a deviation between a predetermined evaporation temperature target value ET_{tgt} [deg C.] and an evaporation temperature ET [deg C.] acquired from the evaporation temperature detector 12 (i.e., ΔET=ET_{tgt}−ET) is input to the PI controller, and the PI controller calculates a compressor frequency at which the evaporation temperature is caused to follow the evaporation temperature target value, and controls the compressor frequency to an arithmetic value U_{comp} [Hz].

$${U}_{comp} = {K}_{pe} Δ ET + {K}_{Ie} \int Δ ETdt \qquad Equation ( 2 )$$

In Equation (2), Kₚₑ is a proportional gain for PI control, and K_{Ie} is an integral gain for PI control. Control performed by the evaporation temperature control unit 212 may be PID control depending on design response or a control target model for design. If there is no deviation from the evaporation temperature target value and only simple control is required, the control performed by the room temperature control unit 211 may be I control.

These control gains such as the proportional gain and the integral gain are designed by a method such as a pole assignment method, a CHR method, or a ZN method. The evaporation temperature control unit 212 needs to be discretized using a microcomputer, a DSP, or similar devices during implementation, but the computation method thereof may be positional or speed-based. For example, the evaporation temperature target value may be a fixed value of 0 [deg C.] or more, may vary in conformity with the set room temperature, or may vary in conformity with a difference between the room temperature and the set room temperature.

The controller of each of the room temperature control unit 211 and the evaporation temperature control unit 212 does not need to be a PI controller. For example, the controller of each of the room temperature control unit 211 and the evaporation temperature control unit 212 may be a controller (e.g., feedback controller) including at least an integrator, such as an I controller or a PID controller.

The controller of each of the room temperature control unit 211 and the evaporation temperature control unit 212 may have an anti-reset windup function of preventing a windup phenomenon. The anti-reset windup function is the function that stops the function of an integrator if it is not selected by a selector, and processes may be performed such as maintenance or automatic matching, on a value immediately before limitation. The controller of each of the room temperature control unit 211 and the evaporation temperature control unit 212 may be constituted by a speed-based PI controller.

As described above, the room temperature control unit 211 and the evaporation temperature control unit 212 operate independently of each other. Consequently, the indoor temperature is individually controlled by the indoor fan 3, and the evaporation temperature is individually controlled by the compressor 4.

FIG. 4 is a flowchart schematically showing an example of a control method for controlling a room temperature and an evaporation temperature in the refrigeration cycle device 1.

As described above, the control method for controlling the room temperature and the evaporation temperature includes the following steps.

Specifically, the control method for controlling the room temperature and the evaporation temperature includes calculating an indoor fan speed at which the room temperature is caused to approach a set room temperature (step S1) and calculating a compressor frequency at which the evaporation temperature is caused to approach an evaporation temperature target value (step S2). In accordance with the indoor fan speed and the compressor frequency calculated in these steps, the control device 2 controls the indoor fan 3 and the compressor 4 (step S3). Consequently, the room temperature is individually controlled by the indoor fan 3, and the evaporation temperature is individually controlled by the compressor 4. The order of step S1 and step S2 is not limited to the example shown in FIG. 4. The process in step S1 and the process in step S2 may progress at the same time.

### Advantages of First Embodiment

In the first embodiment, the indoor fan speed is controlled to keep a comfortable room temperature, and the compressor frequency is controlled to an evaporation temperature to keep a comfortable room humidity. That is, the room temperature is individually controlled by the indoor fan 3, and the evaporation temperature is individually controlled by the compressor 4. Accordingly, the room temperature and the room humidity can be individually controlled, and thus, even in operation under an intermediate load or a heavy load with ventilation, a comfortable room temperature and a comfortable room humidity can be kept.

In addition, according to the first embodiment, a latent heat process (i.e., dehumidification) can be further enhanced by increasing air conditioning capacity itself as well as a ratio between latent heat and sensible heat.

### First Variation

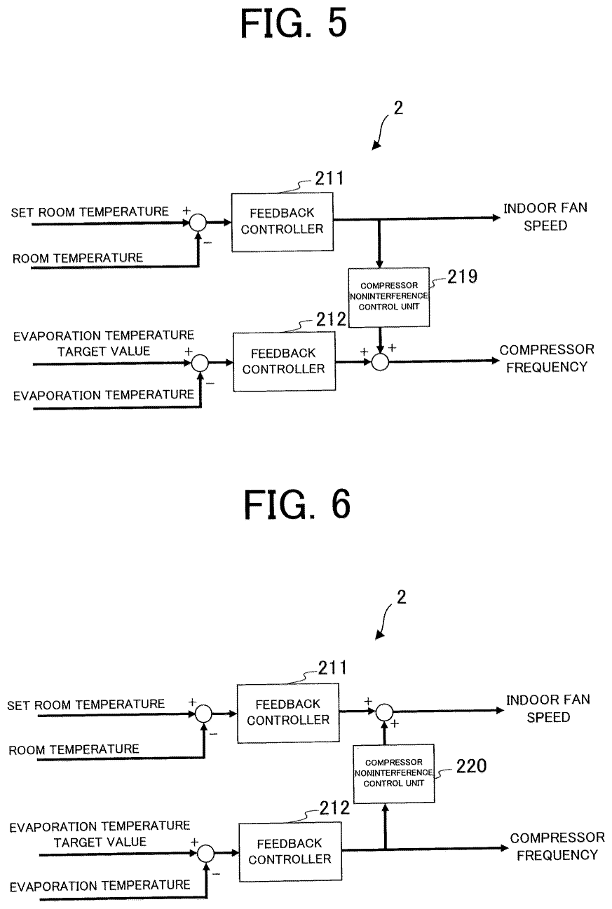

FIG. 5 is a functional block diagram showing another example of the control device 2.

A control device 2 according to a first variation is different from the control device 2 illustrated in FIGS. 1 through 3 in further including a compressor noninterference control unit 219. The compressor noninterference control unit 219 performs control to reduce the influence of the evaporation temperature by the indoor fan 3 through a compressor frequency beforehand. Specifically, the compressor noninterference control unit 219 calculates the frequency of the compressor that increases the compressor frequency of the compressor 4 in a case where the indoor fan speed of the indoor fan 3 increases and that reduces the compressor frequency of the compressor 4 in a case where the rotation speed of the indoor fan 3 decreases.

The compressor noninterference control unit 219 can be designed using a transfer function from the indoor fan speed to the evaporation temperature and a transfer function from the compressor frequency to the evaporation temperature, for example. Suppose the transfer function from the compressor frequency to the evaporation temperature is a process gain K_{ETcomp} of a steady-state response and the transfer function from the indoor fan speed to the evaporation temperature is a process gain K_{ETifan} of a steady-state response, an arithmetic value U_{c_comp} is expressed by Equation (3):

$${U}_{c \_ comp} = - {U}_{ifan} * \frac{{K}_{{ET}_{ifan}}}{{K}_{{ET}_{comp}}} = - {U}_{ifan} * {K}_{comp} \qquad Equation ( 3 )$$

In Equation (3), U_{ifan} may be the indoor fan speed itself or may be a variation ΔU_{ifan} of the indoor fan speed. It is sufficient that an arithmetic operator of speed change is a value corresponding to speed change such as computation using a difference from the previous value or computation using a low-pass filter. In Equation (3), characteristics (i.e., transfer functions) of both are process gains of the steady-state response, but a model in consideration of transition of, for example, a first-order lag system can further reduce the influence of interference. The transfer functions are not limited to this example, and only need to an example that reduces interference.

According to the first variation, the influence on the room temperature caused by the compressor frequency can be avoided.

### Second Variation

FIG. 6 is a functional block diagram showing yet another example of the control device 2.

A control device 2 according to a second variation is different from the control device 2 illustrated in FIGS. 1 through 3 in further including an indoor fan noninterference control unit 220. In general, in the case of controlling an indoor fan and a compressor individually, responsiveness might degrade because of interference of operation of the indoor fan and the compressor. In view of this, the indoor fan noninterference control unit 220 of the second variation performs control to reduce the interference on the room temperature by the compressor 4 beforehand through the indoor fan speed. Specifically, the indoor fan noninterference control unit 220 calculates an indoor fan speed of the indoor fan 3 that reduces the indoor fan speed of the indoor fan 3 in a case where the compressor frequency of the compressor 4 increases and that increases the indoor fan speed of the indoor fan 3 in a case where the compressor frequency of the compressor 4 decreases.

The indoor fan noninterference control unit 220 can be designed using a transfer function from the compressor frequency to the room temperature and a transfer function from the indoor fan speed to the room temperature, for example. Suppose the transfer function from the compressor frequency to the room temperature is a process gain K_{Trcomp} of a steady-state response, and the transfer function from the indoor fan speed to the room temperature is a process gain K_{Trifan} of a steady-state response, an arithmetic value U_{c_ifan} is expressed by Equation (4):

$${U}_{c \_ ifan} = - {U}_{comp} * \frac{{K}_{{Tr}_{comp}}}{{K}_{{Tr}_{ifan}}} = - {U}_{comp} * {K}_{ifan} \qquad Equation ( 4 )$$

In Equation (4), U_{comp} may be a compressor frequency itself, or may be a variation ΔU_{comp} of the compressor frequency. It is sufficient that an arithmetic operator of speed change is a value corresponding to speed change such as computation using a difference from the previous value or computation using a low-pass filter. In Equation (4), characteristics (i.e., transfer functions) of both are process gains of the steady-state response, but a model in consideration of transition of, for example, a first-order lag system can further reduce the influence of interference. The transfer functions are not limited to this example, and only need to an example that reduces interference.

According to the second variation, the influence on the room temperature caused by the compressor frequency can be avoided.

### Third Variation

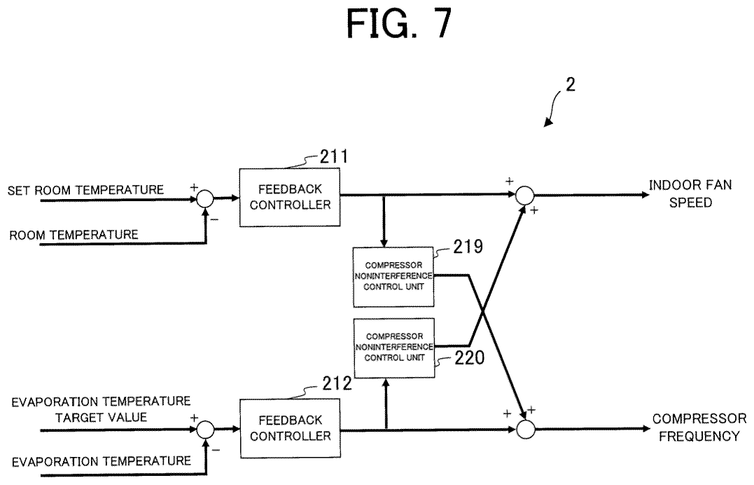

FIG. 7 is a functional block diagram showing still another example of the control device 2.

A control device 2 according to a third variation is different from the control device 2 illustrated in FIGS. 1 through 3 in further including a compressor noninterference control unit 219 and an indoor fan noninterference control unit 220. The compressor noninterference control unit 219 calculates a frequency of the compressor 4 by multiplying a calculation result calculated by the evaporation temperature control unit 212 by a constant. The indoor fan noninterference control unit 220 calculates an indoor fan speed by multiplying a calculation result calculated by the room temperature control unit 211 by a constant.

### Fourth Variation

The refrigeration cycle device 1 illustrated in FIG. 1 may include a liquid trap. This liquid trap is located at the inlet of the compressor 4 and separates a liquid refrigerant that has not evaporated in the evaporator 5. The refrigeration cycle device 1 illustrated in FIG. 1 may further include an injection circuit. In a case where a discharge temperature increases excessively, the injection circuit causes a low-pressure refrigerant to flow into the compressor 4 to reduce the discharge temperature.

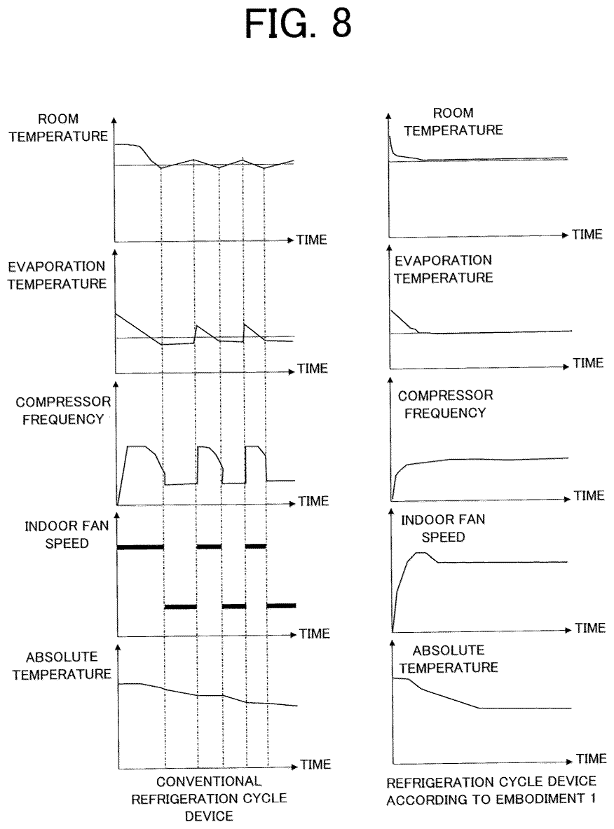

FIG. 8 is a graph showing a comparison between operation in a conventional refrigeration cycle device and operation in the refrigeration cycle device 1 according to the first embodiment.

As illustrated in FIG. 8, in the conventional refrigeration cycle device, when the room temperature reaches a set temperature, operation is switched to dehumidifying operation to rapidly reduce the indoor fan speed. Thus, the compressor frequency might fail to increase because of avoidance of freezing. On the other hand, in the refrigeration cycle device 1 according to the present disclosure, since the indoor fan speed and the compressor frequency are individually controlled, capacity is less likely to decrease.

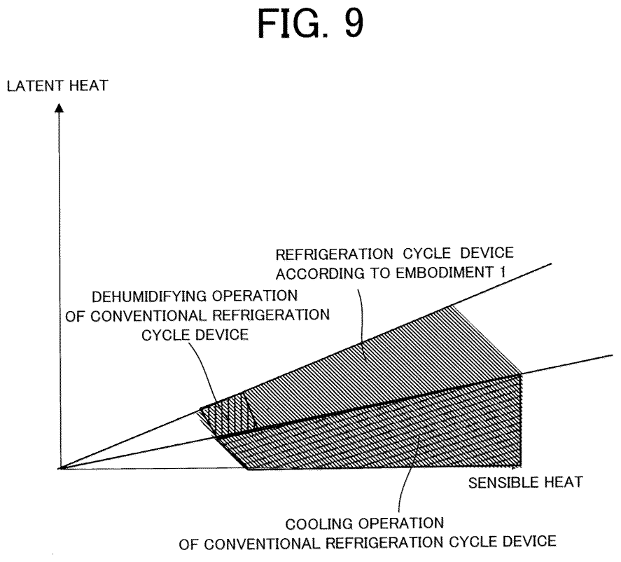

FIG. 9 is a graph showing an operation range of the refrigeration cycle device 1.

As shown in FIG. 9, in the conventional refrigeration cycle device, the airflow rate is reduced during dehumidifying operation, and thus, the refrigeration cycle device can operate only in a range where latent heat and sensible heat are low. On the other hand, the refrigeration cycle device 1 according to the present disclosure can also operate in a range where latent heat and sensible heat are high, and does not switch between the cooling operation and the operation, and thus, discontinuity does not occur in operation. In other words, the refrigeration cycle device 1 according to the present disclosure can operate from a range of conventional cooling operation and conventional dehumidifying operation with a latent heat of 0 kW or more to a range where latent heat and sensible heat are high.

### <Advantages of Refrigeration Cycle Device 1>

According to the present disclosure, the room temperature control unit 211 calculates the indoor fan speed, and the evaporation temperature control unit 212 calculates the compressor frequency. Accordingly, the room temperature and the evaporation temperature can be individually controlled to appropriate values. In other words, the control target and the control unit can be controlled in a one-to-one relationship. That is, a target value of the room temperature and a target value of the room humidity can be individually set, and thus, a decrease in room temperature caused by dehumidifying operation can be prevented, and a comfortable room temperature and a comfortable room humidity can be quickly achieved. As a result, the operation range of the refrigeration cycle device 1 can be enlarged.

In addition, according to the present disclosure, the compressor 4 and the indoor fan speed can be controlled in feedback control by the controller. This configuration can quickly achieve target values.

Furthermore, according to the present disclosure, since operation switching is not performed, the risk of an increase in the room temperature and the return of moisture during dehumidification that occurs at operation switching can be avoided.

### Second Embodiment

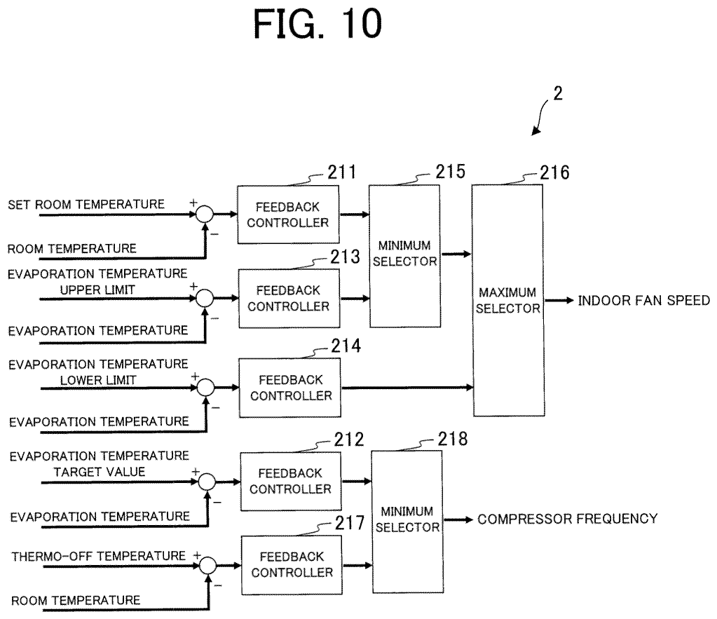

FIG. 10 is a block diagram showing still another example of the control device 2.

A control device 2 according to a second embodiment is different from the control device 2 illustrated in FIGS. 1 through 3 in further including an evaporation temperature upper limit protection control unit 213, an evaporation temperature lower limit protection control unit 214, a primary indoor fan speed selection unit 215, a secondary indoor fan speed selection unit 216, a thermo-off control unit 217, and a compressor frequency selection unit 218, in addition to the room temperature control unit 211 and the evaporation temperature control unit 212.

The evaporation temperature upper limit protection control unit 213 includes a controller that calculates an indoor fan speed at which the evaporation temperature is caused to follow a predetermined evaporation temperature upper limit. The controller of the evaporation temperature upper limit protection control unit 213 includes at least an integrator. In this case, the controller of the evaporation temperature upper limit protection control unit 213 is constituted by, for example, a positional PI controller. The evaporation temperature upper limit protection control unit 213 calculates an indoor fan speed U_{ifan} [rpm] expressed by Equation (5), and outputs a calculation result. The PI controller constituting the evaporation temperature upper limit protection control unit 213 receives a deviation between the predetermined evaporation temperature upper limit ETmax [deg C.] and an evaporation temperature ET [deg C.] acquired from the evaporation temperature detector 12 (i.e., ΔETmax=ETmax−ET). The PI controller constituting the evaporation temperature upper limit protection control unit 213 calculates an indoor fan speed U_{ifan} [rpm] at which the evaporation temperature is caused to follow the evaporation temperature upper limit, and outputs a calculation result.

$${U}_{ifan} = {K}_{p \_ ETmax} Δ ETmax + {K}_{I \_ ET𝔪ax} \int Δ ETmaxdt \qquad Equation ( 5 )$$

In Equation (5), K_{p_ETmax} is a proportional gain for PI control, and K_{I_ETmax} is an integral gain for PI control. Suppose target response is assumed to be a primary delay system, control performed by the evaporation temperature upper limit protection control unit 213 is PI control, and suppose target response is assumed to be a secondary delay system, control performed by the evaporation temperature upper limit protection control unit 213 is PID control. These control gains may be designed by a CHR method, a ZN method, or other methods. The evaporation temperature upper limit protection control unit 213 may be constituted by a speed-based PI controller.

The evaporation temperature lower limit protection control unit 214 includes a controller that calculates an indoor fan speed at which the evaporation temperature is caused to follow a predetermined evaporation temperature lower limit. The controller of the evaporation temperature lower limit protection control unit 214 includes at least an integrator. In this case, the controller of the evaporation temperature lower limit protection control unit 214 is constituted by, for example, a positional PI controller. The evaporation temperature lower limit protection control unit 214 calculates an indoor fan speed U_{ifan} [rpm] expressed by Equation (6), and outputs a calculation result. The PI controller constituting the evaporation temperature lower limit protection control unit 214 receives a deviation between the predetermined evaporation temperature lower limit ETmin [deg C.] and an evaporation temperature ET [deg C.] acquired from the evaporation temperature detector 12 (i.e., ΔETmin=ETmin−ET). The PI controller constituting the evaporation temperature lower limit protection control unit 214 calculates an indoor fan speed U_{ifan} [rpm] at which the evaporation temperature is caused to follow the evaporation temperature lower limit, and outputs a calculation result.

$${U}_{ifan} = {K}_{p \_ ETmin} Δ ETmin + {K}_{I \_ ETmin} \int Δ ETmindt \qquad Equation ( 6 )$$

In Equation (6), K_{p_ETmin} is a proportional gain for PI control, and K_{I_ETmin} is an integral gain for PI control. Suppose target response is assumed to be a primary delay system, control performed by the evaporation temperature lower limit protection control unit 214 is PI control, and suppose target response is assumed to be a secondary delay system, control performed by the evaporation temperature upper lower protection control unit 214 is PID control. These control gains may be designed by a CHR method, a ZN method, or other methods. The evaporation temperature lower limit protection control unit 214 may be constituted by a speed-based PI controller. The evaporation temperature lower limit is, for example, 0 deg C. or more, and smaller than an evaporation temperature target value.

The primary indoor fan speed selection unit 215 is constituted by a selector that selects a minimum value from input values (also referred to as a “minimum selector” or a “first minimum selector”). Specifically, the primary indoor fan speed selection unit 215 selects a minimum value from an output value of the room temperature control unit 211 (i.e., calculation result output from the room temperature control unit 211) and an output value of the evaporation temperature upper limit protection control unit 213 (i.e., calculation result output from the evaporation temperature upper limit protection control unit 213), and outputs the selected minimum value as a selected value.

The secondary indoor fan speed selection unit 216 is constituted by a selector that selects a maximum value from input values (also referred to as a “maximum selector”). Specifically, the secondary indoor fan speed selection unit 216 selects a maximum value from an output value of the evaporation temperature lower limit protection control unit 214 (i.e., calculation result output from the evaporation temperature lower limit protection control unit 214) and an output value of the primary indoor fan speed selection unit 215 (i.e., calculation result output from the primary indoor fan speed selection unit 215), and the indoor fan speed is set at this maximum value (i.e., selected value).

The thermo-off control unit 217 includes a controller that calculates a compressor frequency at which the room temperature is caused to follow a predetermined thermo-off temperature. The controller of the thermo-off control unit 217 includes at least an integrator. In this case, the controller of the thermo-off control unit 217 is constituted by, for example, a positional PI controller. The thermo-off control unit 217 calculates a compressor frequency U_{comp} [Hz] expressed by Equation (7), and outputs a calculation result. The PI controller constituting the thermo-off control unit 217 receives a deviation between a predetermined thermo-off temperature TO [deg C.] and a room temperature Tr [deg C.] acquired from the room temperature detector 11 (i.e., ΔTO=TO−Tr). The PI controller constituting the thermo-off control unit 217 calculates a compressor frequency U_{comp} [Hz] at which the room temperature is caused to follow the thermo-off temperature, and outputs a calculation result.

$${U}_{comp} = {K}_{p \_ to} Δ TO + {K}_{I \_ to} \int Δ TOdt \qquad Equation ( 7 )$$

In Equation (7), K_{p_to} is a proportional gain for PI control, and K_{I_to} is an integral gain for PI control. Suppose target response is assumed to be a primary delay system, control performed by the thermo-off control unit 217 is PI control, and suppose target response is assumed to be a secondary delay system, control performed by the thermo-off control unit 217 is PID control. These control gains may be designed by a CHR method, a ZN method, or other methods. The thermo-off control unit 217 may be constituted by a speed-based PI controller. The thermo-off temperature may be, for example, a value lower than the set room temperature by 3 deg C.

The compressor frequency selection unit 218 is constituted by a selector that selects a minimum value from input values (also referred to as a “minimum selector” or a “second minimum selector”). Specifically, the compressor frequency selection unit 218 selects a minimum value from an output value of the evaporation temperature control unit 212 (i.e., calculation result output from the evaporation temperature control unit 212) and an output value of the thermo-off control unit 217 (i.e., calculation result output from the thermo-off control unit 217), and the compressor frequency is set at this minimum value (i.e., selected value).

The controller of each of the evaporation temperature upper limit protection control unit 213, the evaporation temperature lower limit protection control unit 214, and the thermo-off control unit 217 does not need to be the PI controller. For example, the controller of each of the evaporation temperature upper limit protection control unit 213, the evaporation temperature lower limit protection control unit 214, and the thermo-off control unit 217 may be a controller (e.g., feedback controller) including at least an integrator, such as an I controller or a PID controller. In this application, the “PID controller” refers to a controller including a P controller, an I controller, and a D controller, and the “D controller” refers to a differentiator.

The controller of each of the evaporation temperature upper limit protection control unit 213, the evaporation temperature lower limit protection control unit 214, and the thermo-off control unit 217 may have an anti-reset windup function of preventing a windup phenomenon. The anti-reset windup function is the function of stopping the function of the integrator in a case where an output of an integrator of a target is limited or not selected by a selector, and may perform processes such as maintenance, automatic matching, and so forth, on a value immediately before limitation.

### Advantages of Second Embodiment

The second embodiment has the advantages described in the first embodiment.

In addition, according to the second embodiment, the evaporation temperature upper limit protection control unit 213 calculates an indoor fan speed, and the primary indoor fan speed selection unit 215 selects a minimum value from an output value of the room temperature control unit 211 and an output value of the evaporation temperature upper limit protection control unit 213. This configuration can control the room temperature while protecting an evaporation temperature upper limit for preventing damage of the refrigeration cycle device 1 (e.g., evaporator 5).

Further, the evaporation temperature upper limit protection control unit 213 calculates an indoor fan speed, and the secondary indoor fan speed selection unit 216 selects a maximum value from an output value of the primary indoor fan speed selection unit 215 and an output value of the evaporation temperature lower limit protection control unit 214. This configuration can control the room temperature while protecting the evaporation temperature lower limit and the evaporation temperature upper for preventing limit damage of the refrigeration cycle device 1 (e.g., evaporator 5). In other words, the evaporation temperature lower limit is controlled to a value lower than the evaporation temperature target value, and thus, this can prevent the evaporation temperature from excessively dropping due to the influence of the indoor fan 3.

Moreover, the thermo-off control unit 217 calculates a compressor frequency, and the compressor frequency selection unit 218 selects a minimum value from an output value of the evaporation temperature control unit 212 and an output value of the thermo-off control unit 217. This configuration can control the evaporation temperature to the limit of a thermo-off temperature. That is, dehumidifying operation can be performed to the limit of the thermo-off temperature. Accordingly, it is possible to prevent a decrease in room temperature or thermo-off caused by dehumidifying operation to thereby quickly achieve a comfortable room temperature and a comfortable room humidity.

Furthermore, according to the second embodiment, a target value of the room temperature and a target value of the room humidity can be individually set, and it is possible to enlarge the operation range while protecting the evaporation temperature to avoid damage of the refrigeration cycle device 1 (e.g., evaporator 5).

In addition, according to the second embodiment, a latent heat process (i.e., dehumidification) can be further enhanced by increasing the air conditioning capacity itself as well as a ratio between latent heat and sensible heat.

### Third Embodiment

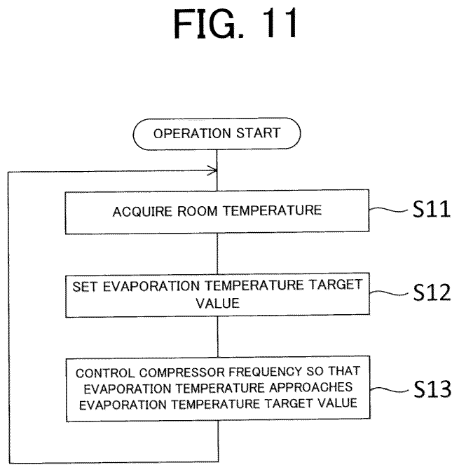

FIG. 11 is a flowchart showing an example of a method for controlling a compressor frequency so that an evaporation temperature approaches an evaporation temperature target value.

A room temperature Tr [deg C.] is detected by a room temperature detector 11 (step S11). For example, a relative humidity H [%] that does not cause discomfort is calculated by Equation (8) using a discomfort index DI and a room temperature Tr [deg C.] obtained from the room temperature detector 11.

$$H = \frac{100 ( DI - 0.81 Tr - 46.3 )}{0 \text{.99} Tr - 14.3} \qquad Equation ( 8 )$$

If the discomfort index DI is 73 or less, few people will feel uncomfortable. As expressed by Equation (9), a saturation water vapor pressure Pws [hPa] at the room temperature is calculated using a room temperature Tr [deg C.] and the Tetens equation. In Equation (9), A, m, and Tn are constants.

$$Pws = A \times {10}^{\frac{m \times Tr}{Tr + Tn}} \qquad Equation ( 9 )$$

Using the saturation water vapor pressure Pws [hPa], a partial water vapor pressure Pw [hPa] that does not cause discomfort is calculated by Equation (10):

$$Pws = Pws \times H / 100 \qquad Equation ( 10 )$$

A dew point Td [deg C.] of the relative humidity that does not cause discomfort is calculated using Tetens equation from Equation (11):

$$Td = \frac{Tn}{\frac{m}{{log}_{10} ( \frac{Pw}{A} )} - 1} \qquad Equation ( 11 )$$

A value obtained by Equation (11) may be used as an evaporation temperature target value, or the value obtained by Equation (11) may be corrected and used as an evaporation temperature target value.

The memory device 23 may store a saturation water vapor pressure table as an index of comfort beforehand, and a saturation water vapor pressure Pws [hPa] may be calculated using this saturation water vapor pressure table.

The refrigeration cycle device 1 may further include a room humidity detector that measures a room humidity. In the case where the refrigeration cycle device 1 includes the room humidity detector, the evaporation temperature target value may be corrected using a room humidity obtained from the room humidity detector. With this method, the evaporation temperature target value is determined using the room temperature detected by the room temperature detector 11 and an index of comfort (step S12).

The control device 2 controls the compressor frequency so that the evaporation temperature approaches the evaporation temperature target value (step S13).

### Advantages of Third Embodiment

The third embodiment has the advantages described in the first embodiment.

In addition, according to the third embodiment, the evaporation temperature target value of the evaporation temperature control unit 212 is calculated by the method described above so that a room humidity that does not cause discomfort under an arbitrary room temperature can be thereby achieved. Further, according to the third embodiment, a room humidity that does not cause discomfort can be achieved without a room hygrometer.

In the case where the refrigeration cycle device 1 includes the room humidity detector, the evaporation temperature target value can be corrected without excessive dehumidification.

Features of the embodiments and variations described above can be combined.

### DESCRIPTION OF REFERENCE CHARACTERS

1 refrigeration cycle device, 2 control device, 3 indoor fan, 4 compressor, 5 evaporator, 6 electronic expansion valve, 7 condenser, 8 outdoor fan, 9 pipe, 10 refrigerant circuit, 11 room temperature detector, 12 evaporation temperature detector, 211 room temperature control unit, 212 evaporation temperature control unit, 213 evaporation temperature upper limit protection control unit, 214 evaporation temperature lower limit protection control unit, 215 primary indoor fan speed selection unit, 216 secondary indoor fan speed selection unit, 217 thermo-off control unit, 218 compressor frequency selection unit, 219 compressor noninterference control unit, 220 indoor fan noninterference control unit.

1. A refrigeration cycle device comprising:
a compressor that compresses a refrigerant;
a condenser;
an expansion valve;
an evaporator;
an indoor fan;
a control device that controls a rotation speed of the indoor fan and a frequency of the compressor;
a room temperature detector that detects a room temperature; and
an evaporation temperature detector that detects an evaporation temperature of a refrigerant in the evaporator, wherein
the control device includes
room temperature control circuitry including a controller that calculates the rotation speed of the indoor fan at which the room temperature is caused to approach a predetermined room temperature, and
evaporation temperature control circuitry including a controller that calculates the frequency of the compressor at which the evaporation temperature is caused to approach a predetermined refrigerant temperature so as to keep a target room humidity,
the room temperature is individually controlled by the indoor fan, the evaporation temperature is individually controlled by the compressor, and
the room temperature and the target room humidity can be individually set.

2. The refrigeration cycle device according to claim 1, wherein the control device further includes compressor noninterference control circuitry, the compressor noninterference control circuitry being configured to calculate the frequency of the compressor that increases the frequency of the compressor in a case where the rotation speed of the indoor fan increases and that reduces the frequency of the compressor in a case where the rotation speed of the indoor fan decreases.

3. The refrigeration cycle device according to claim 1, wherein the control device further includes indoor fan noninterference control circuitry, the indoor fan noninterference control circuitry being configured to calculate the rotation speed of the indoor fan that reduces the rotation speed of the indoor fan in a case where the frequency of the compressor increases and that increases the rotation speed of the indoor fan in a case where the rotation speed of the indoor fan decreases.

4. The refrigeration cycle device according to claim 1, wherein
the control device further includes
evaporation temperature upper limit protection control circuitry including a controller that calculates the rotation speed of the indoor fan at which the evaporation temperature is caused to follow a predetermined evaporation temperature upper limit, and
primary indoor fan speed selection circuitry that selects a minimum value from an output value of the room temperature control circuitry and an output value of the evaporation temperature upper limit protection control circuitry.

5. The refrigeration cycle device according to claim 4, wherein
the control device further includes
evaporation temperature lower limit protection control circuitry including a controller that calculates the rotation speed of the indoor fan at which the evaporation temperature is caused to follow a predetermined evaporation temperature lower limit, and
secondary indoor fan speed selection circuitry that selects a maximum value from an output value of the evaporation temperature lower limit protection control circuitry and an output value of the primary indoor fan speed selection circuitry.

6. The refrigeration cycle device according to claim 1, wherein
the control device further includes
thermo-off control circuitry including a controller that calculates the frequency of the compressor at which the room temperature is caused to follow a predetermined thermo-off temperature, and
compressor frequency selection circuitry that selects a minimum value from an output value of the evaporation temperature control circuitry and an output value of the thermo-off control circuitry.

7. The refrigeration cycle device according to claim 1, wherein
the control device further includes a memory device storing an index of comfort, and
the predetermined refrigerant temperature is determined by using the room temperature and the index of comfort.

8. A control method in a refrigeration cycle device including a compressor that compresses a refrigerant, a condenser, an expansion valve, an evaporator, an indoor fan, a control device that controls a rotation speed of the indoor fan and a frequency of the compressor, a room temperature detector that detects a room temperature, and an evaporation temperature detector that detects an evaporation temperature of a refrigerant in the evaporator, the method comprising:
calculating the rotation speed of the indoor fan at which the room temperature is caused to approach a predetermined room temperature; and
calculating the frequency of the compressor at which the evaporation temperature is caused to approach a predetermined refrigerant temperature so as to keep a target room humidity, wherein
the room temperature is individually controlled by the indoor fan,
the evaporation temperature is individually controlled by the compressor and
the room temperature and the target room humidity can be individually set.
